(19) United States
(12) Patent Application Publication
(10) Pub. No.: US 2025/0326181 A1
(43) Pub. Date: Oct. 23, 2025

(54) LIQUID CRYSTAL THERMOPLASTIC FILAMENT FOR THREE-DIMENSIONAL PRINTING

(71) Applicant: U.S. Army DEVCOM, Army Research Laboratory, Adelphi, MD (US)

(72) Inventors: Eric D. Wetzel, Baltimore, MD (US); Larry C. Dickinson, Hickory, NC (US); Ryan M. Dunn, Belcamp, MD (US); Julian D. Marmo, Pittsburgh, PA (US); Sean P. Walsh, Carrboro, NC (US)

(73) Assignee: U.S. Government, as Represented by the Secretary of the Army, Adelphi, MD (US)

(21) Appl. No.: 19/202,944

(22) Filed: May 8, 2025

Related U.S. Application Data
(63) Continuation-in-part of application No. 16/814,353, filed on Mar. 10, 2020.
Application No. 16/814,353 is a continuation-in-part of application No. 15/630,175, filed on Jun. 22, 2017, now Pat. No. 10,968,539.
(60) Provisional application No. 62/817,161, filed on Mar. 12, 2019.
(60) Provisional application No. 63/645,560, filed on May 10, 2024.

(51) Int. Cl. B29C 64/314; B29C 64/118; B29C 71/02; B29K 101/12; B29K 105/00; B33Y 10/00; B33Y 40/10; B33Y 40/20; B33Y 70/10

(52) U.S. Cl. CPC B29C 64/314; B29C 71/02; B33Y 40/10; B33Y 40/20; B33Y 70/10; B29C 64/118; B29C 2071/022; B29C 2071/025; B29K 2101/12; B29K 2105/0079; B33Y 10/00

(57) ABSTRACT

A thermoplastic filament or preform comprising a thermoplastic liquid crystal polymer (TLCP) is described. It can be incorporated into threads with one or more thermoplastics, where this filament can be used in 3D printing to produce parts that are stiffer and stronger than conventional 3D printed polymers. In one particularly advantageous embodiment, the TLCP is a multi-fiber core that is surrounded by a continuous solid polymer sheath. Also described are unique processing methods for manufacturing these TLCP-containing filaments.

### JOINT RESEARCH RELATED TO THE INVENTION

This invention is a “Subject Invention” which resulted from research and development activities undertaken pursuant to Cooperative Research and Development Agreement (CRADA) Joint Work Statement No. 19-043-001 entitled “Additive Manufacturing of Multi-component Self-Reinforced High-Performance Thermoplastics” between U.S. Army Combat Capabilities Development Command (DEVCOM) Army Research Laboratory (ARL) and 3F, LLC.

### RELATED APPLICATION DATA

This non-provisional patent application claims benefit to U.S. Provisional Patent Application No. 63/645,560 of the same title filed on May 10, 2024. Additionally, this non-provisional patent application is a continuation-in-part (CIP) application of and claims priority to and the benefit of U.S. Non-Provisional application Ser. No. 16/814,353 titled “Multi-material polymer filament for three-dimensional printing” filed on Mar. 10, 2020 which claims the benefit of U.S. Provisional Application No. 62/817,161 titled “Multi-Material Thermoplastic Filament with Regular Geometry for Extrusion Additive Manufacturing” filed on Mar. 12, 2019.

The '353 application in turn is a continuation-in-part (CIP) application of and claims priority to and the benefit of U.S. Non-Provisional application Ser. No. 15/630,175, titled “A process for creating a filament,” filed on Jun. 22, 2017, which the present application also claims priority to.

All of the above-identified provisional and non-provisional patent applications and all documents attached or filed with the above-identified provisional and non-provisional patent applications are hereby incorporated by reference herein.

### GOVERNMENT INTEREST

The invention described herein may be manufactured, used and licensed by or for the U.S. Government.

### FIELD

The present invention relates generally to the field of materials. More specifically, materials and devices are provided for use in production of complex fibers for three-dimensional printing. In particular aspects, materials and material structures are provided that provide superior capabilities in formation of complex fibers.

### BACKGROUND

Fused filament fabrication (FFF) is the most commonly implemented additive manufacturing technique, in terms of volume of material, number of parts made, number of printers sold annually, and number of trained operators. FFF involves feeding a thermoplastic polymer filament into a heated print head, melting the filament, and then extruding the molten filament onto a build plate. The print head and build plate have computer-controlled motion so that the extrudate can placed trace by trace, and layer by layer, to build a 3D part. A typical filament diameter is 1.75 or 2.85 mm, and a typical extrudate diameter is 0.5 mm.

FFF is widely implemented due to a number of key advantages, including low-cost materials and printers, feedstock with very long shelf life, simple operation with low hazards, and accurate geometry. The key disadvantage to FFF is the poor mechanical properties of FFF parts. Between layers, interfaces are very weak due to insufficient time for melt, wetting, and molecular reptation across the interface. Along the trace direction, strength and stiffness values are comparable to injection molded thermoplastics. Chopped or milled fibers, typically carbon/graphite or glass, can be added to the thermoplastic to improve mechanical properties. These chopped fiber loadings rarely exceed 20% vol. which, combined with the small aspect ratios of chopped fibers, results in only modest gains in stiffness and strength compared to unreinforced polymer. Introducing chopped fibers also adds considerable cost, accelerates mechanical wear of printer components such as nozzles, and may also reduce mechanical toughness.

Some commercial and research print technologies have been developed to combine thermoplastic filaments with continuous fibers, typically carbon fiber or glass fiber. These printers are highly specialized for a number of reasons. Continuous fibers cannot stretch, so one cannot continuous feed, melt, and extrude through a conventional converging nozzle; e.g., a 1.75 mm continuous fiber reinforced filament cannot be forced through a 0.5 mm nozzle. To overcome this challenge, specialized print heads are required, such as ones that merge fiber and thermoplastic at the print head, or depositing a pre-impregnated reinforced filament or tow without a reduction in diameter. Another challenge is that stopping material deposition requires a mechanical, thermal, or electrical means of cutting the continuous fiber as it is deposited. For these reasons, there does not exist a continuous fiber feedstock that can be implemented widely in conventional FFF printers, while the continuous fiber printers that do exist are very expensive, challenging to operate, and require proprietary software and material feedstocks.

Thermoplastic liquid crystal polymers (TLCPs) are a special material class. They can be melted and solidified multiple times, like conventional thermoplastics. However, unlike a conventional thermoplastic, their molecules are very stiff (so called “rigid rod” molecules) and tend to align and pack efficiently in the melt. TLCPs therefore are thermotropic liquid crystals, as they form a liquid crystalline state in the melt. This liquid crystalline state encourages molecular orientation and chain extension that can persist as the melt is cooled and solidified, particularly if under a state of shear or extensional flow or stress. By solidifying while under a state of molecular orientation and chain extension, extremely high values of stiffness and strength can be achieved.

One example of a commercial TLCP is Vectra polymer (Celanese/Kuraray), which when spun into oriented fiber is referred to as Vectran. For example, Table 1 compares three grades of Vectran fiber to three thermoplastics that are commonly printed or injection molded. Stiffness values for the TLCP are 7-50× higher, and strength values are 15-100× higher, compared to the conventional thermoplastics.

TABLE 1
Mechanical properties of Vectran TLCP compared to
common injection molded or 3D printed polymers.

| | Stiffness | Strength |
|---|---|---|
| Material | (GPa) | (MPa) |
| Vectran NT | 52 | 1100 |
| Vectran HT | 75 | 3200 |
| Vectran UM | 103 | 3000 |
| ABS | 2.1 | 33 |
| Polycarbonate | 2.2 | 58 |
| Nylon-chopped CF | 8 | 72 |

Some attempts have been made to directly heat and extrude TLCPs to form 3D solids in an FFF printer. However, significant property improvements relative to conventional thermoplastics were only possible under limited print conditions such as extremely small layer heights of 0.05 mm, and achieving bonding between layers to build full solids was problematic. Additionally, a practical challenge with high stiffness filaments for FFF is that they are difficult to spool, often resulting in fracture or kinking when spooled to a practical spool wrap diameter of e.g., 5-10 cm. Wrapping filaments around custom large diameter (e.g., 20-50 cm) spools or feeding discontinuous, straight lengths of filament into a print head could be a workaround but is not practical for many printers or print setups.

As such, there is a need for new materials suitable for use in additive manufacturing processes that allow for improved weldline performance and reduction in the need for post-manufacturing processes thereby improving geometric accuracy, as well as providing complex, cross section fibers that are capable of maintaining geometrical arrangements.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

We disclose thermoplastic liquid crystal polymer (TLCP)-based filaments and preforms that can be 3D printed using conventional FFF printers, and result in very high strength and stiffness solids. A number of key material innovations have been discovered that enable practical printing of TLCPs:

The filaments and preforms are composed of TLCP and one or more thermoplastics that flow at a temperature below (or optionally, above) the melting point of the TLCP, widening processing windows and providing multiple opportunities for improved bonding. For example, after printing, a part can be subject to thermal annealing at a temperature below the melting point or solid-state condensation crosslinking temperature of the TLCP, but above the flow temperature of the secondary thermoplastic. Under these conditions, the secondary thermoplastic can soften, wet, and bond across traces and material layers, resulting in improved strength and toughness. During this annealing process, because the TLCP remains solid, the part geometry does not change due to creep or molecular relaxation.

The TLCP can be a multi-fiber yarn, so that the FFF filament feedstock can include of a multi-fiber yarn core and a thermoplastic sheath. This construction results in a filament with low bending resistance, that can be easily spooled using conventionally sized FFF filament spools. In addition, the use of a multi-fiber yarn within the core can reduce cost, provides consistent linear density, and introduces a highly oriented molecular state that encourages strength and stiffness.

The TLCP core can be twisted, braided or served to improve handling.

The TLCP fibers can be combined with, at a fiber lever, with a third thermoplastic (different from the TLCP and sheath polymers) to encourage bonding and load sharing with the TLCP fibers, while also expanding processing windows for printing and annealing.

The thermoplastic sheath can be a continuous single thermoplastic, multiple thermoplastics, or comprise a wrapped, twisted, served, or braided sheath.

We also disclose a number of key process innovations:

The TLCP yarn(s) can be surface treated prior to compositing with other thermoplastic(s), to improve bonding from TLCP to the other thermoplastic(s). Atmospheric plasma and solvent treatment are some examples of surface treatments.

Thermoplastic coating routes as well as more conventional approaches such as wire coating, can be used to produce the filament.

Specialized print head nozzle geometries can be used to induce high orientation while maintaining part build rates. These nozzles can be easily swapped into nearly all existing FFF printers.

Moreover, specialized print heads can be designed to induce TLCP orientation while still allowing for bonding of the secondary polymer.

These and other embodiments of the invention are described in more detail, below.

### BRIEF DESCRIPTION OF THE DRAWINGS

The embodiments herein will be better understood from the following detailed description with reference to the drawings, in which:

FIG. 1 is a schematic of a filament for 3D printing, comprising a multi-fiber TLCP core and a sheath of a secondary thermoplastic.

FIG. 2 is a schematic of a filament for 3D printing, comprising a multi-fiber TLCP core and a sheath of a secondary thermoplastic, where some or all of the TLCP fibers are coated with a third thermoplastic.

FIG. 3 is a schematic of a filament for 3D printing, comprising a multi-fiber TLCP core and a sheath of a secondary thermoplastic, where a plurality of a third thermoplastic fiber is co-mingled with the TLCP fibers.

FIG. 4 is a schematic of a filament for 3D printing, comprising a multi-fiber TLCP core and a sheath comprising a second and third thermoplastic.

FIG. 5 is a schematic of a filament for 3D printing, comprising a multi-fiber TLCP core and a secondary thermoplastic that forms both a sheath on the filament and filament walls as part of the filament core.

FIG. 6 is a schematic of a filament for 3D printing, comprising a twisted multi-fiber TLCP core and a sheath of a secondary thermoplastic, where the sheath optionally comprises a braided thermoplastic, and where the core twist angle is 0.

FIG. 7 is a schematic of a process for making filament for 3D printing, in which a multi-fiber thread of TLCP is surface treated to improve bonding; fed through the center of a hollow thermoplastic preform; the preform is heated and thermally drawn to a smaller diameter while coating the thread; and the filament is then provided to a 3D printer for building a 3D solid.

FIG. 8 is a schematic of a process for making filaments for 3D printing, in which a thread of multi-fiber TLCP is surface treated to improve bonding, fed through a coating die, and then collected onto a spool.

FIG. 9 is a schematic of a process for making a 3D solid via 3D printing, in which a filament comprising a multi-fiber TLCP core and a sheath of a secondary thermoplastic is fed into a print head; heated above the flow temperatures of the TLCP and secondary thermoplastic; pushed through a nozzle; and deposited onto a build plate. The nozzle orifice geometry can be a simple circle (a), a multi-circle array (b), a flat ribbon (c), or a multi-armed star (d).

FIG. 10 is a schematic of a process for making a 3D solid via 3D printing, in which a filament comprising a multi-fiber TLCP core and a sheath of a secondary thermoplastic is fed into a print head; heated to a temperature T₁, above the flow temperatures of the TLCP and secondary thermoplastic; pushed and/or pulled through the through a primary nozzle to generate elongational flow; pushed through a secondary heated body and nozzle, at a temperature T₂ below the flow temperature of the TLCP but above the flow temperature of the secondary polymer; and deposited onto a build plate.

FIG. 11 is a schematic of a spool of a TLCP filament.

FIG. 12 is a micrograph showing a cross-section of a TLCP filament, showing a PC sheath and a multi-fiber TLCP core.

FIG. 12 is a plot showing Modulus and strength data for printed TLCP bars, compared to printed PC and ABS bars.

FIG. 13 is a plot showing the results of tensile testing, as well as comparable data for printed PC and ABS bars.

FIGS. 14A and 14B are micrographs of TLCP extrudate from print head, and FIG. 14C shows mechanical properties of TLCP extrudate as a function of print temperature.

FIG. 15 shows solids 3D printed using PC-coated A115 TLCP are parameters of the printing.

FIG. 16 is a plot of tensile testing results for 3D printed specimens using PETG-coated, densified TLCP core filament, compared with benchmark materials, along with parameters of the printing.

FIG. 17 shows 3D solids printed using PETG-coated, densified TLCP core filament.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc. Certain inventive features are further provided through tables including design and analysis details as supported by the written description.

### DETAILED DESCRIPTION OF THE INVENTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

The present invention enables printing of TLCPs into high strength, high stiffness solids, improving significantly upon the mechanical properties of existing printed thermoplastics, and overcoming prior challenges associated with printing of TLCPs. The resulting solid is a 3D printed, continuous fiber-reinforced composite.

It will be understood that when an element is referred to as being “on” another element, it can be directly on the other element or intervening elements may be present therebetween. In contrast, when an element is referred to as being “directly on” another element, there are no intervening elements present.

And it will be understood that, although the terms “first,” “second,” “third” etc. may be used herein to describe various elements, components, regions, layers, parameters and/or sections, these elements, components, regions, layers, parameters, and/or sections should not be limited by these terms. These terms are only used to distinguish one element, component, region, layer, parameter, or section from another element, component, region, layer, parameter, or section. Thus, “a first element,” “component,” “region,” “layer,” “parameter,” or “section” discussed below could be termed a second (or other) element, component, region, layer, parameter, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

We build upon the innovation earlier described in the '353 and '175 non-provisional patent applications, the disclosures of which, as earlier mentioned, were incorporated by reference herein. In brief, those applications disclose: A thermoplastic filament comprising multiple polymers of differing flow temperatures in a geometric arrangement and an interior channel containing a structural or functional thread therein is described. A method for producing such a filament is also described. Because of the difference in flow temperatures, there exists a temperature range at which one polymer is mechanically stable while the other is flowable. This property is extremely useful for creating thermoplastic monofilament feedstock for three-dimensionally printed parts, wherein the mechanically stable polymer enables geometric stability while the flowable polymer can fill gaps and provide strong bonding and homogenization between deposited material lines and layers. These multimaterial filaments can be produced via thermal drawing from a thermoplastic preform, which itself can be three-dimensionally printed. Furthermore, the preform can be printed with precisely controlled and complex geometries, enabling the creation of a filament or fiber with an interior thread contained within the outer, printed filament or fiber. This thread adds structural reinforcement or functional properties, such as electrical conductivity or optical waveguiding, to the filament.

For the sake of brevity here, we will not re-describe those disclosures in this application beyond this simple summarizing. The reader can certainly read those earlier applications' descriptions for additional details and information. We note that same express definitions used in those applications are incorporated herein and used accordingly, unless further updated and/or distinguished herein which shall supplement their definition herein.

As used herein the term “filament” is an elongated material formed by the process of drawing, such as thermal drawing, from a preform to a cross-sectional dimension that is less than the corresponding cross-sectional dimension of the preform. More particularly, it refers to the feedstock used for 3D printing, usually a long cylindrical body with a diameter 1 mm or larger. More commonly, a single filament is called “monofilament.”

As used herein the term “preform” is a three-dimensional body of two or more materials with differing mechanical, physical, optical, electrical, or other desired properties arranged in a regular or irregular fashion and suitably dimensioned so as to allow the preform to be drawn into the form of a filament.

As used herein, the term “thermoplastic liquid crystal polymer (TLCP)” means a thermotropic liquid crystal polymer, in which the melt state of the polymer exhibits molecular ordering. TLCPs capture a wide range of polymer chemistries that exhibit thermotropic behavior. In the art, these types of materials may be referred to as “thermotropic liquid crystal polymer” with the same acronym. Typically, the molecules are rigid rod molecules with some intermolecular attraction that encourages alignment and registry between molecules. The most successful commercial TLCP is Vectra, produced and marketed by Kuraray (Japan) and Celanese (US). Vectra polymer, when spun into a high-performance fiber, is known by its trade name Vectran. Other TLCPs include Zenite (Celanese) and Laperos (Polyplastics, Japan). A summary of commercial grades of TLCP can be found in Ji et al. “Progress of liquid crystal polyester (LCP) for 5G application,” Advanced Industrial and Engineering Polymer Research 3.4 (2020): 160-174; all grades of TLCP including those mentioned in Ji et al. are to be considered relevant to the present disclosure.

As used herein the term “flow temperature,” is defined as any characteristic polymer temperature, such as a softening (i.e. T_{g}, glass transition) or melting point that can be used to compare the thermal properties of different polymers and which in part determines appropriate drawing and printing process conditions for a given polymer system. For a TLCP, the melt temperature is the most appropriate flow temperature, as the material is generally a non-flowable solid below the melt temperature. For Vectra and Vectran TLCP, the melt temperature is approximately 285° C.

As used herein, the term “multi-fiber yarn” refers to a yarn comprising a large number (e.g., hundreds or thousands) of fine individual fibers. A typical fiber diameter is between 0.1 and 500 micrometers, although more preferably, they can be 0.2-200 μm, to form a multi-fiber yarn having a diameter of about 1-3 mm. For instance, we have found 5-30 μm is fine enough to achieve high molecular orientation during fiber spinning, and fine enough to make a flexible and drapeable material. The more typical term of art is a “multi-filament yarn,” as opposed to a “multi-fiber yarn.” A “filament” or “preform” refers to larger diameter materials (e.g., 1-3 mm) that are used as feedstock for 3D printing. As used herein, the term “co-mingled yarn” refers to a multi-fiber yarn that contains more than one composition of fiber.

As used herein, the term “regular geometric arrangement” is defined as a constant or defined pattern or patterns with specific and defined spaces between individual instances where the overall geometric arrangement has a repeatability of geometric shape, size, or orientation of one element relative to another element on the same or different device recurring at a fixed interval of distance.

As used herein, the term “periodic geometric arrangement” is a regular geometric arrangement with a specific periodicity of an element shape, size, or other characteristic appearing and/or recurring at a fixed interval or intervals.

As used herein the term “physically associated” is defined as in physical contact throughout at least a portion of one element relative to a second element.

The filament or preform may be in the form of a cylinder, a rectangular prism, elongated prism structure with a cross-sectional area in the shape of a circle, square, rectangle, trapezoid, hexagon, pentagon, other polygon as desired, or an irregular outer shape of the cross-sectional area.

As used herein, the term “thread” refers to a material element that is coated or composited with another material to form a composite filament for 3D printing. The thread can be for example introduced into a thermal draw process, or into a wire coating die, where it is coated with a secondary polymer material. Thread includes, but is not limited to, any single filament fiber, multi-fiber yarn, solid wire, braided, stranded wire and combinations thereof. The co-drawn, continuous threads could be structural, for example glass, carbon or Kevlar fibers; conductive, for example fine copper wire; or functional, for example glass or polymer optical fiber. The threads could be densified at some point during filament manufacturing, for example via the application of heat, tension, twist, or pressure. Herein, the thread is generally referring to a body comprising TLCP thread(s).

As used herein, the term “annealing” refers to subjecting a part to elevated temperature for an extended period of time, where the elevated temperature is higher than the flow temperature of one of the material constituents of the part. Annealing times can be seconds, minutes, hours, days, or weeks. Airflow, convection, thermal radiation, and immersion baths can all be used to enhance annealing. Liquid or vapor solvents and plasticizers may also be introduced to enhance the annealing process. Annealing herein does not refer to the specialized solid-state condensation crosslinking reaction that can be initiated in a TLCP below the flow temperature (melt temperature) of the TLCP.

The multi-fiber LCP yarns can be modified or prepared to increase their cohesion and packing density prior to filament production. For example, the multi-fiber yarns can be twisted, braided or served. As used herein, the term “served” refers to the process where secondary yarn is wrapped or wound around the core LCP yarn to keep it compacted and protect it during handling. The secondary yarn can be LCP or another polymer fiber.

Provided herein are multi-component materials that are in the form of a preform or a filament 10A-10G useful as an end product or for further processing to form an article such as by methods of three-dimensional printing. By combining two or more materials that differ in one or more properties into the configuration of a preform, the geometric arrangement of the preform is maintained throughout a drawing process so as to produce a filament with desired uses, configurations, or properties that are not easily obtainable by other filament manufacturing methods. A filament as provided herein can be used as an end product itself, can be further drawn into a smaller cross-sectional dimension for other uses or for the manufacture of an article such as by three-dimensional printing or other process. A filament has a stable cross-sectional interrelationship between two or more materials that are included in the filament. Such cross-sectional stability is achieved in some aspects by creation of a larger preform with the desired interrelationship and drawing the preform into the form of a filament by a process such as thermal drawing. As such, the interrelationships provided between materials as described herein for a filament are also provided for the description of a preform with the exception of physical dimensions thereof which are larger in a preform. Much of the description is directed to filaments for use in three-dimensional printing, but it is equally appreciated that such filaments are suitable for many other uses and in many other configurations as is appreciated by one of ordinary skill in the art in view of the description provided herein.

According to embodiments, the filaments or preforms include two thermoplastic polymer materials that differ in flow temperature by 100 C. or greater. It has been found that in some FFF processes, the upper limit of flow temperature differences should be employed. As such, optionally, the two polymer materials differ in flow temperature by 100 C. to 150° C., optionally 10° C. to 50° C., or any value or range therebetween. Optionally, the two polymer materials differ in flow temperature by 100 C. to 300 C. or any value or range therebetween.

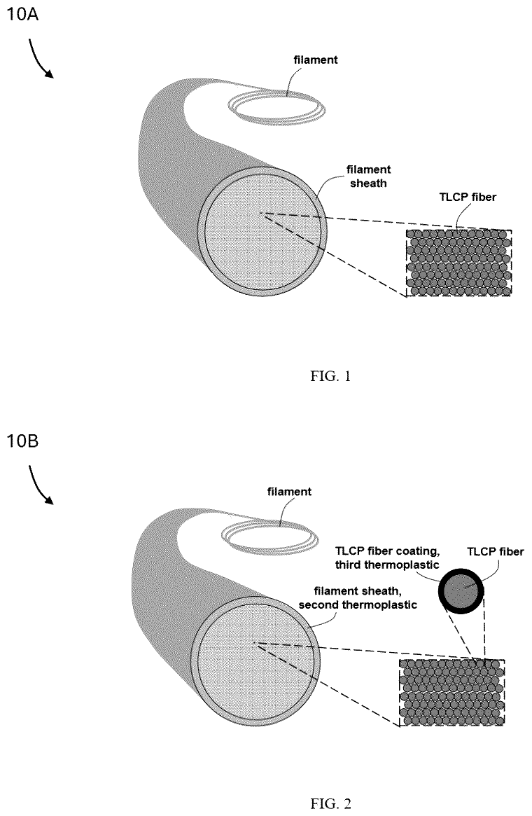

One key innovation is the formation of a composite filament 10A comprising TLCP as one component (i.e., a first thermoplastic polymer), and a secondary thermoplastic as a second component (i.e., a second thermoplastic polymer) (FIG. 1). For instance, the first thermoplastic polymer may comprise a copolymer of one or more of the following monomers: 4-hydroxybenzoic acid (HBA); 6-hydroxy-2-naphthoic acid (HNA); hydroquinone (HQ); phthalic acid (terephthalic acid or isophthalic acid, TPA or IPA); 2,6-nedioic acid (NDA); 4,4′-bisphenol (BP); p-aminobenzoic acid (PAA); poly (ethylene terephthalate) (PET); styryl hydroquinone (StHQ); or phenylhydroquinone (PhHQ), as some non-limiting examples.

In one embodiment, the second thermoplastic has a flow temperature lower than the flow temperature of the TLCP. This filament can be printed by heating the filament above the flow temperatures of both the TLCP and secondary thermoplastic and then depositing the filament onto a build plate. The secondary thermoplastic is typically configured as a sheath surrounding the TLCP core and serves multiple purposes. One purpose is to contain the TLCP core, specifically when the TLCP core is configured as a multi-fiber yarn. A second purpose is to provide resistance to longitudinal and transverse compression, so that the filament can be fed through a conventional print head using drive wheels to advance the filament. A third purpose is to form a tough, high adhesion matrix during printing to form a cohesive 3D solid and promote load transfer to the reinforcing TLCP phase.

A second key innovation is the use of a multi-fiber core, rather than a solid core, in the filament. Conventional 3D printing filaments are fully solid, making them simple to produce (i.e. via melt extrusion), spool, and feed through an FFF print head. When working with very stiff materials such as TLCP, however, a fully solid filament is difficult to wrap around a spool without breakage and/or kinking. Because all FFF printers require a spooled filament, the inability to spool very stiff filaments creates a significant barrier to implementation. In the present invention, the core comprises one or more multi-fiber yarns or tows. Even though the core is made of extremely high stiffness material, the filament is bendable due to the small diameter of the tows (e.g., 10-30 μm); this behavior is due to the fact that the bending stiffness of a cylinder is proportional to its diameter cubed. Another advantage of a multi-fiber core is that it can take advantage of existing multi-fiber TLCP yarns. Thus, the multi-fiber yarns comprising the first thermoplastic polymer can be twisted, braided or served. Likewise, the second thermoplastic might also be configured as one or more multi-fiber yarns which are twisted, braided or served. For example, 1500 denier Vectran yarns are commercially available and can be used singly or as a combination of multiple yarns to form a filament core.

Another advantage of these multi-fiber yarns is that they are spun to exactingly consistent linear densities; therefore, the resulting linear density of a filament that uses commercially available multi-fiber yarns will also be highly consistent. In contrast, if a TLCP is extruded as a solid core, it can be challenging to maintain precise linear density during extrusion. Precise linear density is critical to high quality FFF printing, because the control algorithms for FFF printers are based on the assumption of consistent linear density; any negative or positive deviations in local linear density of the filament will result in under-extrusion or over-extrusion flaws, respectively, in the resulting printed solid. A final advantage of TLCP fiber feedstocks is that their spinning process induces a high degree of chain orientation and extension, which is critical to achieving high strength and stiffness. Therefore, as the TLCP filament enters the print head, it is already in an optimal molecular configuration. Although the material is melted in the print head, it is possible that starting from an optimal oriented state increases the likelihood of maintaining that state in the extruded melt and printed solid. Said differently, for a less desirable, molecularly misoriented TLCP filament feedstock, the print head would need to have the critical features necessary to drive orientation during the print process, rather than simply maintaining an existing orientation state.

The second thermoplastic may include one or more of a thermoplastic material selected from the group consisting of: acrylonitrilebutadienestyrene (ABS); high density polyethylene (HDPE); low density polyethylene (LDPE); polyamide (PA); polyamide imide (PAI); polyarylate (PAR); polyaryletherketone (PAEK); polybutylene terephthalate (PBT); polycarbonate (PC); polyester; polyether sulfone (PES); polyetherketoneketone (PEKK); polyetheretherketone (PEEK); polyetherimide (PEI); polyetherketone (PEK); polyetherketonetherketoneketone (PEKEKK); polyethlyene (PE); polyethylene terephthalate (PET); polyimide (PI); polylactic acid (PLA); polymethyl methacrylate (PMMA); polyoxymethylene (POM); polyphenylene oxide (PPO); polyphenylene sulfide (PPS); polyphenylsulfone (PPSU); polyphthalamide (PPA); polyphthalate carbonate (PPC); polyproplyene (PP); polystyrene (PS); polysulfone (PSF); polyurethane (PU); polyvinyl chloride (PVC); polyvinylidene fluoride (PVDF); styrene acrylonitrile (SAN); styrene maleic anhydride (SMA); ultrahigh molecular weight polyethylene (UHMWPE); high impact polystyrene (HIPS); polyvinyl alcohol (PVA); glycol-modified polyethylene terephthalate (PETG); polytetrafluoroethylene (PTFE); thermotropic liquid crystalline polymers such as copolymers of 4-hydroxybenzoic acid (HBA) and 6-hydroxy-2-naphthoic acid (HNA).

The second thermoplastic can be chosen based on a number of factors, including improving handling, enabling bonding, and manipulating melt conditions to induce optimal TLCP orientation. The secondary thermoplastic can be amorphous or semi-crystalline. Typical amorphous thermoplastics would include ABS, PETG, ASA, PC, and PEI. Typical semi-crystalline thermoplastics could include PP, PE, PLA, nylon, PEEK, PEKK, PSU, and PPSU. In a preferred embodiment, the secondary thermoplastic has a flow temperature below that of the TLCP so that, after printing, the part can be annealed to higher strength. For example, with a PC sheath, a printed part can be annealed at 200° C. for 15 h to promote bonding between PC, whose flow temperature could be considered its T_{g} at around 150° C. Because this annealing temperature is far below the melting point of TLCP (285° C.), the TLCP will not deform during annealing, supporting the part geometry so that it does not creep or relax during annealing. Moreover, multi-fiber yarn(s) formed of TLCP are able to provide the filament or preform with a tensile elastic modulus of at least 20 GPa or has a tensile strength of at least 500 MPa in some embodiments.

A third thermoplastic can be introduced into the process to further improve composite performance. The third thermoplastic polymer can be physically associated in a geometric arrangement with the first and second thermoplastic polymers, wherein the flow temperature of said third thermoplastic polymer is at least 10 degrees Celsius lower than a flow temperature of said first thermoplastic polymer, and wherein a flow temperature of said third thermoplastic polymer is at least 10 degrees Celsius higher or 10 degrees lower than said second thermoplastic polymer. Many geometric arrangements are possible. For instance, (i) the third thermoplastic polymer comprises a coating on one or more of the fibers; (ii) the third thermoplastic polymer comprises a multi-fiber yarn that is adjacent to the first thermoplastic polymer multi-fiber yam; (iii) the third thermoplastic polymer comprises a multi-fiber yarn that is co-mingled with the first thermoplastic polymer multi-fiber yam; (iv) the third thermoplastic polymer comprises a multi-fiber yarn that is wrapped, wound, or served around the first thermoplastic multi-fiber yarn; or (v) the third thermoplastic polymer is adjacent to the second thermoplastic polymer.

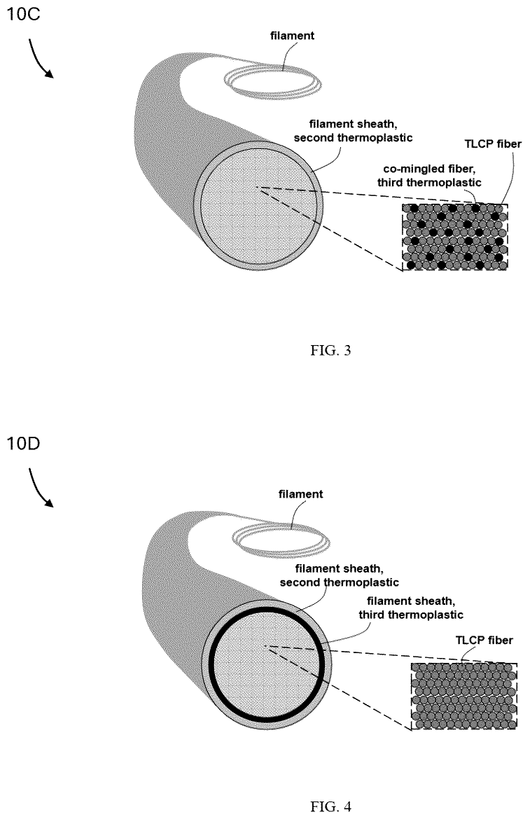

In one embodiment, one or more individual TLCP fibers are coated with a third thermoplastic to produce filament 10B (FIG. 2). In another embodiment, fibers of a third thermoplastic are co-mingled with the TLCP fibers to produce filament 10C (FIG. 3). In another embodiment, the sheath comprises a second thermoplastic and third thermoplastic, for example as a coaxial multi-layer sheath, to produce filament 10D (FIG. 4). The use of multiple thermoplastics provides opportunities for improved functionality and performance. In one embodiment, the third thermoplastic polymer could be a very low flow temperature polymer designed for high adhesion to TLCP, while the second thermoplastic polymer could have a higher flow temperature so that its melt viscosity is sufficiently high to enable high quality FFF printing without stringing or slumping. In another embodiment, the third thermoplastic polymer could be an amorphous polymer designed for enhanced bonding and high melt viscosity during printing, while the second thermoplastic is a semicrystalline polymer designed for high solvent resistance that protects the amorphous third thermoplastic during use.

Thus, in one embodiment, we provide for a filament or preform comprising a first thermoplastic polymer and a second thermoplastic polymer, the filament or preform having an outer surface. The first thermoplastic polymer and the second thermoplastic polymer are physically associated in a geometric arrangement, in which a flow temperature of said first thermoplastic polymer is at least 10 degrees Celsius higher than a flow temperature of said second thermoplastic polymer, and wherein at least 90% of the outer surface is comprised of the second thermoplastic polymer. The first thermoplastic polymer is configured as one or more multi-fiber yarns comprising a thermoplastic liquid crystal polymer. The diameter of the filament or preform is between 1 and 3 mm and the filament or preform is configured to be 3D printed into an object using a 3D printer which accepts continuous filaments with a diameter of at least 1 mm.

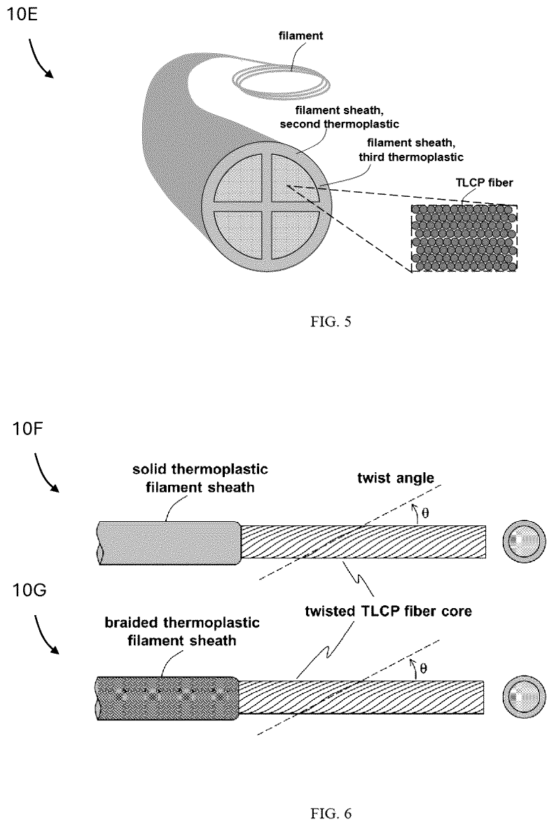

The second thermoplastic can be a simple sheath, or it can be a sheath combined with structural elements that support the core of the filament 10E (FIG. 5). In one embodiment, the sheath is continuous with internal walls that divide the filament into multiple lobes (in the cross-section of the fibers) in a regular geometric arrangement, and each lobe is filled with TLCP fibers. The internal walls provide support that assists with feeding the fiber through the print head and provide a finer dispersion of the secondary thermoplastic throughout the 3D printed solid.

Some improvements in handling and feeding are possible by introducing twist into the multi-fiber core to form filament 10F (FIG. 6, top). Twist is particularly advantageous for stabilizing the filament as it is fed through the drive wheels of the print head, by limiting or preventing longitudinal buckling and transverse compressive crushing of the filament. It may be characterized by a twist angle θ. The twist angle θ is preferably greater than 1° but less than 900 or, more preferably, the twist angle is greater than 5° but less than 45°. In another embodiment, the core can be braided or served. The thermoplastic sheath can be a continuous solid thermoplastic or, in another embodiment, the sheath can be a braided sheath comprising the secondary thermoplastic, to form filament 10G (FIG. 6, bottom). One advantage of a braided sheath is that it can be very thin compared to the TLCP core, so the resulting volume fraction of TLCP in the printed solid can be very high.

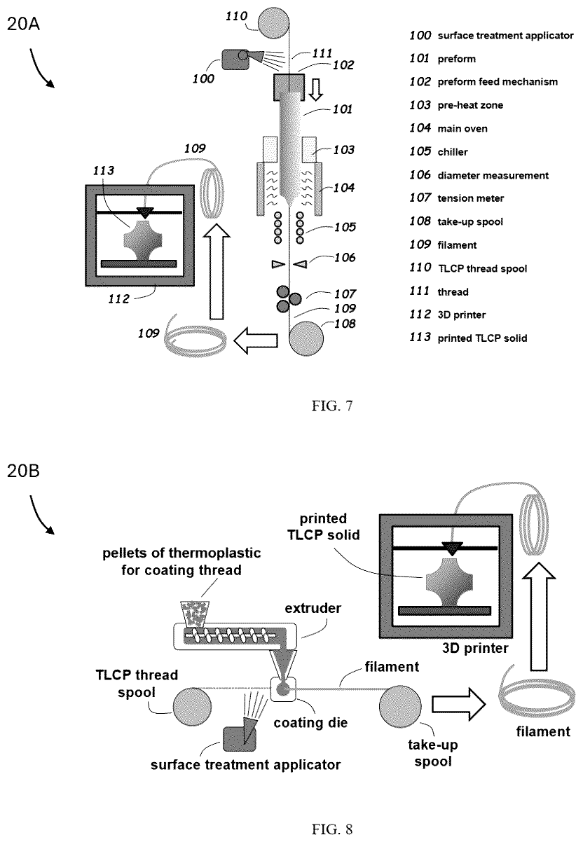

FIGS. 7-10 are schematics of various processing lines 20A-20D which can be employed to produce the filaments and preforms according to various embodiments.

One process for filament fabrication is to feed a multi-fiber thread of TLCP through the center of a hollow preform comprising a second thermoplastic; and thermally drawing that second thermoplastic to the desired final filament diameter while entraining the TLCP thread using processing line 20A (FIG. 7). This process was generally described in '175 application, which issued as U.S. Pat. No. 10,968,539, including the use of a TLCP thread.

To improve bonding between the first and second thermoplastics, the first thermoplastic polymer, the second thermoplastic polymer, or both may include additives, compatibilizers, etchants, sizings, or coatings. One improvement is the use of a surface treatment to enhance bonding between the TLCP and the second thermoplastic. This surface treatment can be inline as part of the thermal draw process, or a process that is performed separately to the thread prior to mounting the thread into the thermal draw process. Example surface treatments include atmospheric plasma, thermally-curing a polymer coating, UV-curing a polymer coating, chemical etching, flame etching, coupling agent coating, chemical sizing, spray coating, solvent immersion, solvent mist, or solvent spraying. Because of the fundamental challenges associated with bonding to TLCP, these surface treatments can be critical for achieving ultimate mechanical properties.

Another embodiment of a filament production process is the use of a coating die, such as in a wire coating apparatus in processing line 20B (FIG. 8). The thread of TLCP is fed through a coating die, which typically holds a bead of a second thermoplastic melt fed by a melt extruder. The thread is coated with secondary thermoplastic in the wire coating die, and the coating quickly solidifies as it exits the die and is cooled by air or liquid. Wire coating is a more common industrial process for thermoplastics compared to thermal drawing, so this method is likely to have an advantage of increased production rates and reduced cost compared to thermal draw. Other thermoplastic coating methods such as pultrusion, powder coating, solvent coating, powder coating, and spray coating can also be used.

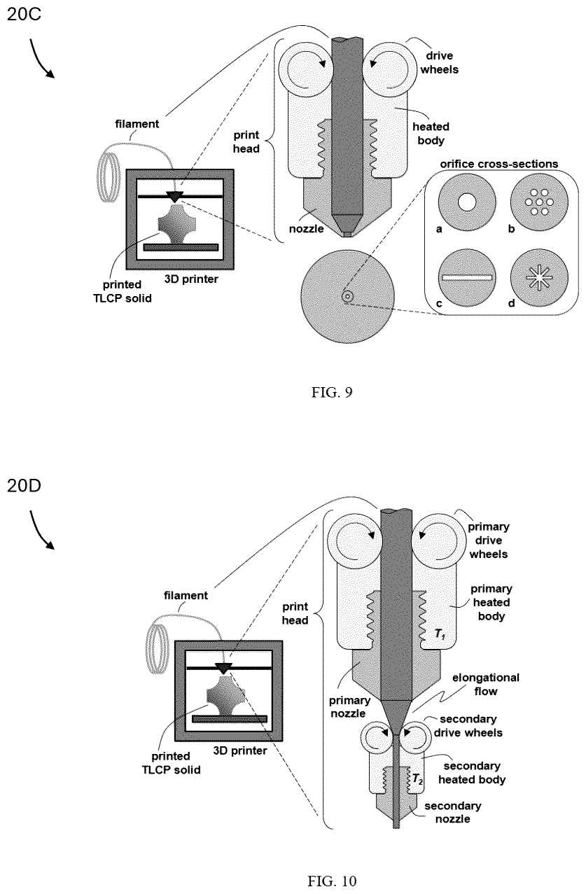

The TLCP filament is envisioned as a feedstock for 3D printing via FFF. In an FFF print head, drive wheels force the filament into a heated body, which heats the filament above its softening point; the melt is then pushed through a converging nozzle, creating molten extrudate that is deposited onto a build plate. A conventional nozzle comprises a single orifice with a typical diameter of 0.4 mm, although other nozzle diameters such as 0.2, 0.3, 0.5, 0.8, and 1.0 mm are sometimes used. The optimal strength and stiffness properties in a TLCP part arise from achieving high molecular orientation and chain extension. One way to encourage orientation and chain extension is to introduce high shear and elongational flows to the TLCP melt. Reducing orifice diameter is one way to increase shear and elongation rates within the nozzle. However, reducing orifice diameter also reduces build rates due to the lower cross-sectional area. An improved approach is to increase shear and elongation without significantly reducing build rates, by using specialized nozzle diameters in processing line 20C (FIG. 9). The nozzle orifice geometry can be a simple circle (a), a multi-circle array (b), a flat ribbon (c), or a multi-armed star (d). The nozzle can be designed that maintains a conventional extrudate cross-sectional area but, by virtue of the reduced gap between orifice boundaries, results in increased extrudate shear. A second benefit of these unconventional nozzle shapes is that they provide a higher surface area to volume ratio compared to a simple cylindrical extrudate. This surface area will accelerate cooling, which reduces the time necessary to solidify the TLCP, increasing the likelihood of freezing the oriented TLCP state before it can relax or mis-orient as a free extrudate melt. Thus, the process may further include a step of actively cooling the three-dimensional object to rapidly freeze the deposited filament. For instance, active cooling may be achieved using fans, liquid spray, liquid immersion, refrigerated air, refrigerated surfaces, or Peltier cooling, as a few non-limiting examples. Because nozzle mounting threads are generally universal across many FFF printing platforms, and nozzles are relatively low cost to produce, it is practical to retrofit a specialized nozzle to an existing FFF to enhance the mechanical performance of printed TLCP parts.

In another embodiment, a specialized print head is used to print TLCP filament in processing line 20D (FIG. 10). The objective of this print head is to provide optimal extensional flow to orient the TLCP, similar to the melt spinning process used to produce TLCP fibers. As stated earlier, both shear and extensional flow can drive molecular extension and orientation. However, shear flows have a disadvantage in that they encourage orientation but also introduce tumbling of molecules accordingly to a statistical probability. Therefore, shear flow is likely to lead to a modest degree of orientation. In contrast, elongational flows do not introduce tumbling, and can drive TLCPs to a state of nearly perfect chain extension and orientation. Conventional print heads have a converging nozzle with a mixture of shear and elongational flows and therefore may not achieve optimal molecular orientation and mechanical properties. The specialized print head shown in FIG. 10 is designed to provide elongational flow in the print head. In the primary heating stage, the filament is heated to a temperature T₁ above the flow temperature of the TLCP without significant diameter reduction. The filament melt is then introduced to a set of secondary drive wheels, which stretches the molten filament and creates elongational flow in the melt. The melt then enters a secondary heated body at a lower temperature T₂<T₁, where it is then fed through a second nozzle with little or no convergence before being extruded and deposited to build a part. The second temperature T₂ is below the melt temperature of the TLCP, so that the elongational state of the TLCP induced during stretch is frozen in place. The second temperature T₂ is above the flow temperature of the second thermoplastic polymer in the filament sheath, so that upon deposition the sheath can bond to the build plate or prior layers of material. The primary and secondary drive wheels are computer controlled to provide optimal extensional rates and draw ratios, while temperatures T₁ and T₂ are selected to control the relative flowability of each material phase. This specialized printing method would not work with a single material filament and is enabled using both a TLCP and secondary thermoplastic within the print filament.

In another embodiment, a thread is provided comprising TLCP as well as one or more additional thermoplastics. The TLCP can consist of continuous fibers or discontinuous fibers. For example, it could have a void volume fraction in the yarn is less than about 10-15%. Where the LCP fibers are coated with a thin layer of a third polymer, and then that yarn can be heated and densified to form a solid filament; that filament may then be coated with the second thermoplastic to form the filament for 3D printing.

The thread can consist of TLCP fibers individually coated with a third thermoplastic; or co-mingled with fibers of a third thermoplastic; or intercalated with a third thermoplastic powder. This thread may also be subject to a densification process (alternatively referred to as a “fusing” process), for example applying tension and twisting simultaneous with heat. Although many heating conditions can be considered, heat is most advantageous to be below the melting temperature of the TLCP while above the softening temperature of the third thermoplastic. In this scenario, the thread is bonded into a contiguous, densified solid thread. The application of pressure, vacuum, or mechanical compaction can be used to increase internal bonding and remove voids or trapped air. This densified thread can be used directly as a filament for printing; or can be sheathed with a second thermoplastic. For example, a co-feed thermal draw process can be used to coat, clad, or sheath the densified TLCP thread by passing it through an orifice in a preform, which is then heated, tensioned, and necked down to continuous coat the thread. Alternatively, the densified TLCP thread can be passed through a molten polymer stream, such as in an extrusion wire coating process, to continuously coat the thread.

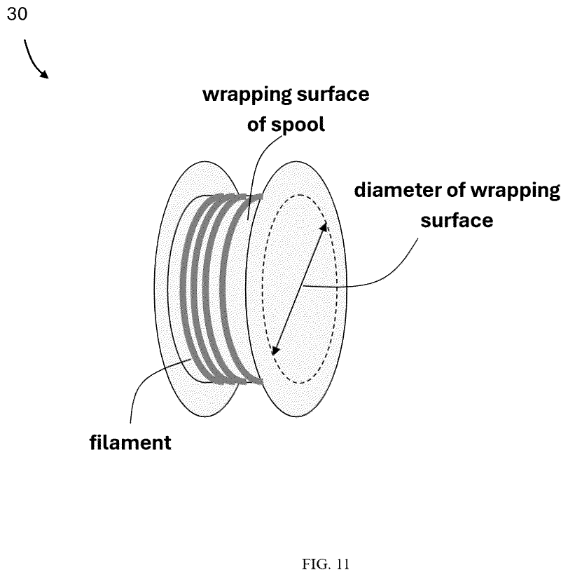

In one preferred embodiment, though, the filament has a multi-fiber yarn core with undense packing which allows the filament to be placed on a spool 30 (FIG. 11). The spool is used in a 3D printer to provide a compact storage and dispensing system for long continuous lengths of filament. A dense core material cannot be readily spooled, it is too stiff. This provides for a spool of filament configured for 3D printing. The spool can include a wrapping surface with a diameter about 10 cm or smaller (and even more preferably less than 6 cm in diameter), so that the filament or preform (e.g., at least 10 m in length) is wrapped around the wrapping surface of the spool such that at least 30 cm of the filament length is substantially in contact with the wrapping surface of the spool. More preferably, the minimum diameter of the spool where the filament is wrapped around is no more than about 6 cm. The spooled filament is continuous and long, that is, it is wrapped around the spool such that at least one circumference (e.g., 10 cm dia.×Pi is ˜31.4 cm) is substantially in contact with the wrapping surface of the spool. More preferably, a very long length of filament (e.g. 100s of m in length) will be wrapped 100s of times around the spool, providing a continuous length of filament that can be used to 3D print one or more parts of substantial volume without having to load another filament spool into the 3D printer.

The selection of thermoplastics can serve multiple functions, including enhanced mechanical properties, solvent resistance, adhesion, printability, or thermal or electrical conductivity. For example, a sheath thermoplastic can be selected with a lower softening temperature, or a lower melt viscosity, than the core thread components. When used as a printer filament, the flowability of the sheath can reduce print head back pressure, improve gap filling during deposition, improve bonding during printing, and make the structure amenable to post-print annealing. For example, if the sheath material has a softening temperature that is lower than the softening temperature of the TLCP or of the third thermoplastic in the densified thread core, then a solid printed from this filament can be placed in an oven at a temperature above the softening temperature of the sheath but below the softening temperature of the thread. Under this temperature condition, the part will undergo an annealing process that strengthens the bonds between sheath polymer domains leading to overall higher strength.

In another embodiment, physical interlocking between traces and layers are exploited to improve load transfer between traces and layers. For example, a specialized filament shape or nozzle shape can be used to create extrudate that has raised, lowered, curved, protruding, bumpy, raised, or barbed features that are designed to create or enhance mechanical coupling between traces and layers. Alternatively, the traces can be deposited in a manner to create waves, loops, curves, or bumps that can be used for mechanical interlocking, or to increase or manipulate surface contact between layers and traces and thereby increase mechanical strength, stiffness, or toughness.

In another embodiment, the TLCP is reinforced with solid fillers. The solid fillers may be chopped fibers, milled fibers, organic fibers, inorganic fibers, glass powder, glass beads, glass fibers, carbon fibers, graphite platelets, boron nitride platelets, metal powder, metal fibers, or combination thereof, as non-limiting examples. Nano-scale fillers like carbon nanotubes, or nanoparticles of silica or titania, could be included into fine TLCP threads with a thread diameter of 1-100 um. However, other fillers have a larger diameter, for example 1-10 um in diameter, required TLCP threads reinforced by these fillers to have a diameter that is preferably larger than 100 um. One exemplary filler is chopped glass fibers. These glass-reinforced TLCP threads could be formed into filament via coating with a sheath of a second thermoplastic with a lower softening temperature than the TLCP. One advantage of this embodiment is that the TLCP reinforced by chopped glass is a significantly cheaper feedstock than continuous multi-fiber yarns of pure TLCP. A second advantage is that the glass fiber can improve mechanical or thermal stability for cases where full molecular orientation of the TLCP is not possible. A disadvantage of this approach is that the cores can become very stiff, making the filament difficult to spool. Spooling the filament can sometimes be achieved by forcing the filament to wrap around the spool, leading to visible buckling, and in some cases fracture, of the filament core. The protective sheath of second polymer can help to reduce the likelihood of fracture or buckling of the TLCP core, or at least hide the appearance of buckling or fracture that otherwise might impact the visual attractiveness and consistency of the filament as a commercial product.

### Examples

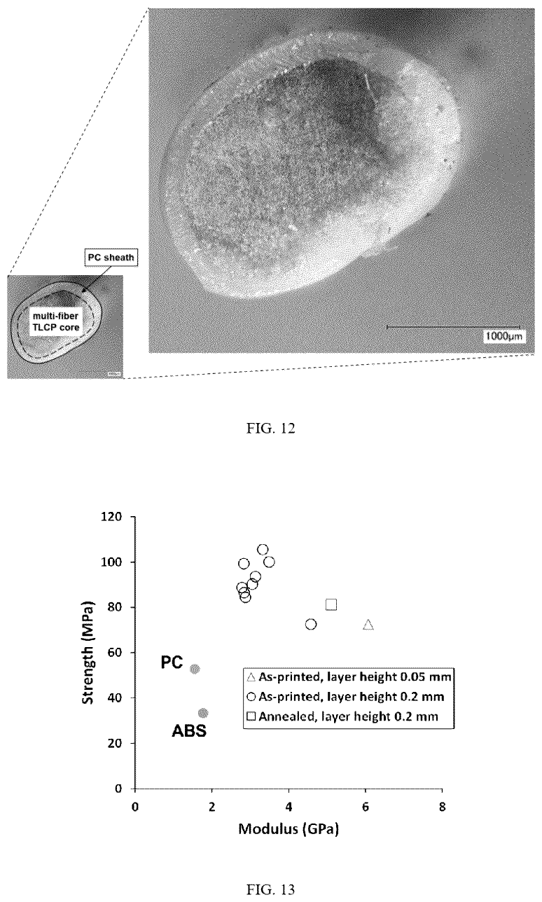

In an example TLCP filament production process, ten 1500 denier Vectran NT yarns were strung out in parallel over a 30 m span (300 m of total yarn). A cordless drill was used to twist the yarns to approximately 30 twists per m, and the twisted yarns were then wrapped around a spool. The spool of TLCP was taken to a thermal draw tower, where a tube of 3D printed polycarbonate (PC) tube (Stratasys PC-10, Eden Prairie, MN) with an OD of 25.4 mm, an ID of 18.0 mm, and a length of 150 mm was mounted. The TLCP yarn was then fed down the center of the PC tube, which was progressively heated to 250° C. along its length while applying tension. The heat and tension caused the PC tube to neck down continuously to form filament with a 2 mm OD, which was collected and wrapped around a spool for subsequent 3D printing. They produced a thin PC sheath and densely packed TLCP fiber core, as shown in FIG. 12. The filament shape was elliptical due to the pressure of the take-up rollers during thermal drawing. A gentler take-up system, such as a pair of long traction belts, would be more likely to produce a round filament.

We used this process to 3D print a TLCP hollow cube. This demonstration part was printed using a LulzBot TAZ Workhorse 3D printer, with a nozzle temperature of 295° C., bed temperature of 95° C., layer height of 0.2 mm, line width of 0.5 mm, and nozzle diameter of 0.5 mm. The part quality is excellent, with good dimensional accuracy and robust layer-to-layer adhesion. The PC phase is translucent, so that it is possible to see the PC and TLCP phases in the printed part. The printed cube showed consistent extrudate diameter, packing, and adhesion over dozens of material layers.

The same filament and printer were used to 3D print bars for tensile testing, with a nominal dimension of 6 mm wide, 1 mm high, and 80 mm long. These bars were printed with a perimeter fill pattern, effectively a uniaxial test coupon. Samples were directly gripped for tensile testing, with an effective gage length of 50 mm. The load frame is an MTS Synergie with a 5 kN load cell, loaded at 0.6 mm/min. After printing, some samples were subject to thermal annealing at 200° C. for 15 hrs. FIG. 13 is a plot showing the results of tensile testing, as well as comparable data for printed PC and ABS bars. Strength and stiffness values are outstanding for the TLCP bars, with modulus values as high as 6 GPa and strength values exceeding 100 MPa. Both of these values are 2-3× higher than the conventional PC and ABS bars. The failure region of an exemplar TLCP specimen shows a fine fibrillated structure, which is typically associated with molecular chain extension and alignment. This failure mode suggests that the printing process has successfully generated a desirable molecular configuration in the TLCP.

Additional experiments were performed by extruding TLCP filament from a printer but collecting the extrudate directly rather than using it to build a 3D solid. The extrudate can be deposited using a suitable extrusion pattern, such as oscillations, humps, beads, loops, or hooks to encourage mechanical interlocking between adjacent deposited traces and layers.

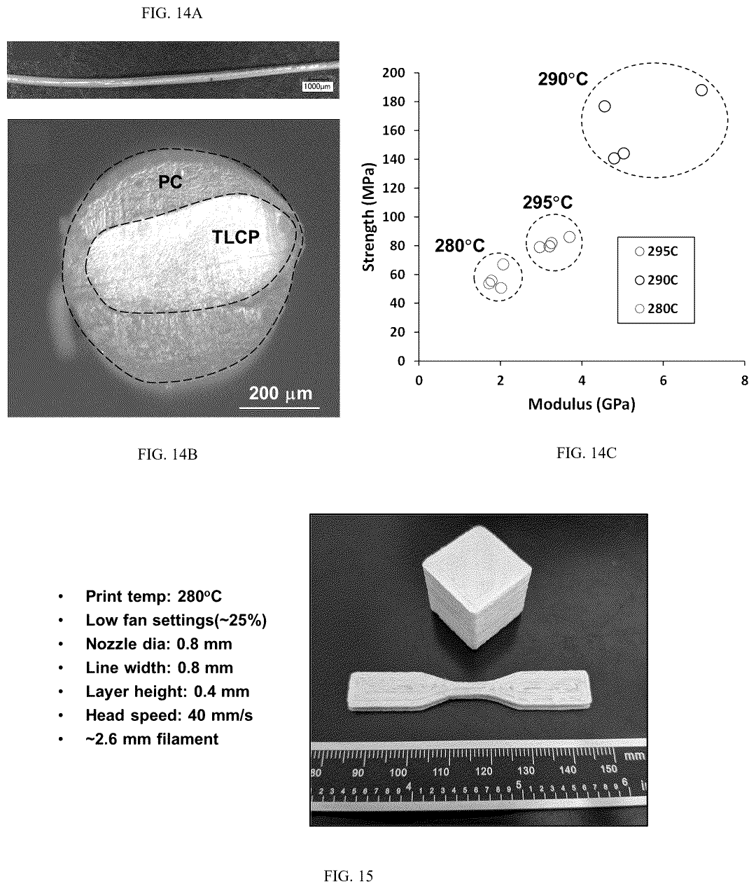

FIGS. 14A and 14B show this extrudate and FIG. 14C is a plot of tensile test data for the extrudate. Area analysis of the extrudate cross-sectional area suggests a TLCP volume fraction of 40%. Strength and stiffness values for the extrudate are exceptional, with modulus and strength values approaching 8 GPa and 200 MPa, respectively.

These experiments demonstrate reduction-to-practice of the process and materials necessary to enable 3D printing of TLCP based upon an FFF feedstock with a multi-fiber TLCP core. In a second embodiment, the filament or preform comprises a first thermoplastic polymer and a second thermoplastic polymer, the filament or preform having an outer surface. The first thermoplastic polymer and the second thermoplastic polymer are physically associated in a geometric arrangement, in which a flow temperature of said first thermoplastic polymer is at least 10 degrees Celsius higher than a flow temperature of said second thermoplastic polymer, and wherein at least 90% of the outer surface is comprised of the second thermoplastic polymer. The diameter of the filament or preform is between 1 and 3 mm is configured to be 3D printed into an object using a 3D printer which accepts continuous filaments with a diameter of at least 1 mm.

In the next embodiment, the first thermoplastic polymer includes a thermoplastic liquid crystal polymer mixed with solid fillers. The solid fillers may be chopped fibers, milled fibers, organic fibers, inorganic fibers, glass powder, glass beads, glass fibers, carbon fibers, graphite platelets, boron nitride platelets, metal powder, metal fibers, or combination thereof, as non-limiting examples. For instance, these glass fibers are typically 1-10 um in diameter, so the first thermoplastic polymer in this case would need to be at least 100 um in diameter.

In one such exemplary embodiment, the TLCP takes the form of a solid extrudate of Kuraray Vectra A115, an injection molding grade TLCP with 15% added chopped glass fibers. This material was received as pellets, then dried and extruded in a twin screw polymer melt extruder to form monofilament at 1.5-2.0 mm diameter. This A115 filament thread was then coated by co-feeding the A115 thread down the center of a polycarbonate tube in the thermal draw apparatus. The polycarbonate in this case was transparent extruded polycarbonate tubing, 25.4-mm-OD and 19.1-mm-ID, purchased from McMaster Carr (Elmhurst, IL). The product, PC-coated A115 TLCP filament has a reasonably round cross-sectional shape showing a distinct TLCP core and PC sheath. This product could be spooled into/onto compact spools. In contrast, attempts to spool the uncoated A115 extruded filament resulted in significant kinking and breaking of the filament. These results suggest that the PC sheath is supporting the solid A115 core in a manner that limits or prevents kinking.

This A115 was fed into a LulzBot TAZ 6 printer, with a nozzle temperature of 280° C., layer height of 0.4 mm, line width of 0.8 mm, and nozzle diameter of 0.8 mm. The material was difficult to print with smaller diameter nozzles, most likely due to the presence of chopped glass fiber in the filament. As shown in FIG. 15, a solid cube and dogbone specimen were printed with this configuration, which demonstrated good quality and adhesion.

Tensile testing specimens were printed and tested under comparable conditions. Strength and stiffness values were excellent, at 94 MPa and 5.6 GPa, respectively. Four samples were annealed after printing at 175° C. for 72 h, and one sample was annealed at 185° C. for 8 h. The resulting strength and stiffness properties for the first annealed set were 119 MPa and 7.1 GPa, and 102 MPa with 4.8 GPa for the sample annealed at a higher temperature. These are excellent mechanical properties. However, as we found, the extrudate quality is inconsistent. The presence of chopped glass fibers in particular appears to introduce challenges with consistent extrudate. In addition, the relatively large nozzle size of 0.8 mm was found to be necessary to extrude the material. An additional round of test specimens was fabricated with the extrusion multiplier adjusted to slightly over-extrude traces, resulting in improved visible fill quality. Mechanical test results however were not improved relative to prior experiments, with strength and stiffness values of 81 MPa and 4.7 GPa. Another set of samples was printed and tensile tested with less grip pressure, sandpaper on the grips to reduce sample damage, and a higher extension rate of 6 mm/min; one of these samples resulted in a strength of 129 MPa with a modulus of 6.2 GPa.

Additional material was fabricated by 3D printing a PETG tube (3DXTech Max G) at 1-in OD and 0.71-in ID and using the thermal draw co-feed process to create filament. The core was comprised of a densified thread containing TLCP and PETG polymers. The TLCP thread was also densified by subjecting to heat, tension, and twist to create a continuous, solid, compacted and densified thread core; this process is sometimes referred to as “fusing.” This densified core was fed into the thermal draw process to create a filament with a densified TLCP-PETG core, and a PETG cladding. Four filament variants were produced in this manner:
VA5-T+PETG: PETG-clad, overall TLCP volume fraction of 23%
XF8R11, no PETG: no PETG-cladding, overall TLCP volume fraction of 75%
XF8R11+PETG, Draw 3: PETG-clad, overall TLCP volume fraction of 50% (third run)
XF8R11+PETG, Draw 5: PETG-clad, overall TLCP volume fraction of 50% (fifth run)

In all these cases, the core was densified and included PETG amongst the continuous TLCP fibers.

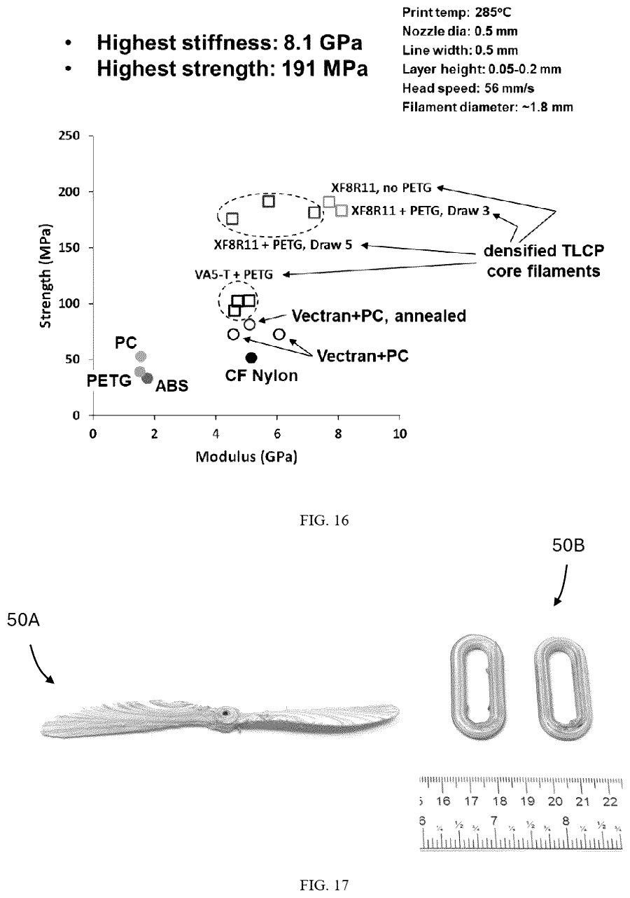

FIG. 16 shows the results for mechanical testing of printed tensile test coupons. In addition to coupons printed using a densified core, comparisons are made with samples printed from earlier filaments with a twisted continuous core that was not densified (Vectran+PC); and commercial printed specimens including PC (Stratasys PC-10), ABS (Stratasys M30), PETG (3DXTech Max G), and chopped carbon fiber reinforced nylon (Essentium HTN CF-25). The results show that the densified core TLCP samples are twice as strong as any of the commercial filaments, and exhibit stiffness up to 50% higher than the best performing commercial filament (carbon fiber reinforced). FIG. 17 shows more complex part geometries, including a propellor 50A and chain links 50B, printed using some of the PETG-clad, densified core TLCP filaments.

Various modifications of the present invention, in addition to those shown and described herein, will be apparent to those skilled in the art of the above description. Such modifications are also intended to fall within the scope of the appended claims.

Patents, publications, and applications mentioned in the specification are incorporated herein by reference to the same extent as if each individual patent, publication, or application was specifically and individually incorporated herein by reference.

The foregoing description is illustrative of particular aspects of the invention, but is not meant to be a limitation upon the practice thereof. The following claims, including all equivalents thereof, are intended to define the scope of the invention.

1. A filament or preform comprising a first thermoplastic polymer and a second thermoplastic polymer, the filament or preform having an outer surface;
wherein the first thermoplastic polymer and the second thermoplastic polymer are physically associated in a geometric arrangement, in which a flow temperature of said first thermoplastic polymer is at least 10 degrees Celsius higher than a flow temperature of said second thermoplastic polymer, and wherein at least 90% of the outer surface is comprised of the second thermoplastic polymer; and
wherein the first thermoplastic polymer is configured as one or more multi-fiber yarns comprising a thermoplastic liquid crystal polymer; and
wherein the diameter of the filament or preform is between 1 and 3 mm; and
further wherein the filament or preform is configured to be 3D printed into an object using a 3D printer which accepts continuous filaments with a diameter of at least 1 mm.

2. The filament or preform of claim 1, wherein the multi-fiber yarns comprising the first thermoplastic polymer are twisted, braided or served.

3. The filament or preform of claim 2, wherein the fibers are twisted having a twist angle greater than 5° but less than 45°.

4. The filament or preform of claim 1, wherein the first thermoplastic polymer, the second thermoplastic polymer, or both comprises additives, compatibilizers, etchants, sizings, or coatings to improve bonding between the first and second thermoplastics.

5. The filament or preform of claim 1, wherein the first thermoplastic polymer comprises a copolymer of one or more of the following monomers: 4-hydroxybenzoic acid (HBA); 6-hydroxy-2-naphthoic acid (HNA); hydroquinone (HQ); phthalic acid (terephthalic acid or isophthalic acid, TPA or IPA); 2,6-nedioic acid (NDA); 4,4′-bisphenol (BP); p-aminobenzoic acid (PAA); poly (ethylene terephthalate) (PET); styryl hydroquinone (StHQ); or phenylhydroquinone (PhHQ).

6. The filament or preform of claim 1, wherein the individual fibers of the multi-fiber yarn have a diameter between 0.2 micrometers and 200 micrometers.

7. The filament or preform of claim 1, wherein the second thermoplastic is configured as a solid sheath, coating, or cladding substantially surrounding the first thermoplastic.

8. The filament or preform of claim 1, wherein the second thermoplastic is configured as one or more multi-fiber yarns.

9. The filament or preform of claim 8, wherein the multi-fiber yarns of the second thermoplastic are twisted, braided or served.

10. The filament or preform of claim 1, where the second thermoplastic polymer comprises a volume of material that forms an outer band of the filament or preform, and where the band thickness is at least 5% of the diameter of the filament or preform.

11. The filament or preform of claim 1, wherein the second thermoplastic comprises one or more of a thermoplastic material selected from the group consisting of: acrylonitrilebutadienestyrene (ABS); high density polyethylene (HDPE); low density polyethylene (LDPE); polyamide (PA); polyamide imide (PAI); polyarylate (PAR); polyaryletherketone (PAEK); polybutylene terephthalate (PBT); polycarbonate (PC); polyester; polyether sulfone (PES); polyetherketoneketone (PEKK); polyetheretherketone (PEEK); polyetherimide (PEI); polyetherketone (PEK); polyetherketonetherketoneketone (PEKEKK); polyethlyene (PE); polyethylene terephthalate (PET); polyimide (PI); polylactic acid (PLA); polymethyl methacrylate (PMMA); polyoxymethylene (POM); polyphenylene oxide (PPO); polyphenylene sulfide (PPS); polyphenylsulfone (PPSU); polyphthalamide (PPA); polyphthalate carbonate (PPC); polyproplyene (PP); polystyrene (PS); polysulfone (PSF); polyurethane (PU); polyvinyl chloride (PVC); polyvinylidene fluoride (PVDF); styrene acrylonitrile (SAN); styrene maleic anhydride (SMA); ultrahigh molecular weight polyethylene (UHMWPE); high impact polystyrene (HIPS); polyvinyl alcohol (PVA); glycol-modified polyethylene terephthalate (PETG); polytetrafluoroethylene (PTFE); thermotropic liquid crystalline polymers such as copolymers of 4-hydroxybenzoic acid (HBA) and 6-hydroxy-2-naphthoic acid (HNA).

12. The filament or preform of claim 1, wherein the multi-fiber yarn has a tensile elastic modulus of at least 20 GPa or has a tensile strength of at least 500 MPa.

13. The filament or preform of claim 1, where the cross-section is divided into two or more sections in a regular geometric arrangement, where the sections are bounded by the second polymer, and the first polymer multi-fiber yarn substantially fills one or more of the sections.

14. The filament or preform of claim 1, further comprising a third thermoplastic polymer that is physically associated in a geometric arrangement with the first and second thermoplastic polymers, wherein the flow temperature of said third thermoplastic polymer is at least 10 degrees Celsius lower than a flow temperature of said first thermoplastic polymer, and wherein a flow temperature of said third thermoplastic polymer is at least 10 degrees Celsius higher or 10 degrees lower than said second thermoplastic polymer.

15. The filament or preform of claim 14, wherein (i) the third thermoplastic polymer comprises a coating on one or more of the fibers; (ii) the third thermoplastic polymer comprises a multi-fiber yarn that is adjacent to the first thermoplastic polymer multi-fiber yarn; (iii) the third thermoplastic polymer comprises a multi-fiber yarn that is co-mingled with the first thermoplastic polymer multi-fiber yarn; (iv) the third thermoplastic polymer comprises a multi-fiber yarn that is wrapped, wound, or served around the first thermoplastic multi-fiber yarn; or (v) the third thermoplastic polymer is adjacent to the second thermoplastic polymer.

16. The filament or preform of claim 14, wherein the multi-fiber yarn is a contiguous, densified solid thread comprising the first and third thermoplastics.

17. A spool of filament configured for 3D printing comprising:
a spool having a wrapping surface with a diameter about 10 cm or smaller;
a filament according to claim 1, wherein the filament is continuous, and
wherein the filament is at least 10 m in length, and
wherein the filament is wrapped around the wrapping surface of the spool such that at least 30 cm of the filament length is substantially in contact with the wrapping surface of the spool.

18. A filament or preform comprising a first thermoplastic polymer and a second thermoplastic polymer, the filament or preform having an outer surface;
wherein the first thermoplastic polymer and the second thermoplastic polymer are physically associated in a geometric arrangement, in which a flow temperature of said first thermoplastic polymer is at least 10 degrees Celsius higher than a flow temperature of said second thermoplastic polymer, and wherein at least 90% of the outer surface is comprised of the second thermoplastic polymer; and
wherein the first thermoplastic polymer comprises a thermoplastic liquid crystal polymer mixed with solid fillers; and
wherein the diameter of the filament or preform is between 1 and 3 mm; and
further wherein the filament or preform is configured to be 3D printed into an object using a 3D printer which accepts continuous filaments with a diameter of at least 1 mm.

19. The filament or preform of claim 18, wherein the solid fillers comprise chopped fibers, milled fibers, organic fibers, inorganic fibers, glass powder, glass beads, glass fibers, carbon fibers, graphite platelets, boron nitride platelets, metal powder, metal fibers, or combination thereof.

20. A process for creating a polymer filament or preform of claim 1, said process comprising:
providing a supply of a thread that comprises a first thermoplastic polymer, wherein the first thermoplastic polymer is configured as one or more multi-fiber yarns comprising a thermoplastic liquid crystal polymer;
loading a second thermoplastic polymer into a wire-coating die, wherein the second thermoplastic material is different from said first thermoplastic polymer, and wherein a flow temperature of the second thermoplastic polymer is at least 10 degrees Celsius lower than a flow temperature of said first thermoplastic polymer;
applying a treatment to the thread to enhance bonding;
inserting the thread into the wire coating die;
drawing the thread under tension through the molten stream of the second thermoplastic polymer so that the thread is coated with the second thermoplastic polymer to form the filaments so that at least 90% of the outer surface of the filament is comprised of the second thermoplastic polymer.

21. A process for creating a three-dimensional object, said process comprising:
providing a first thermoplastic polymer is configured as one or more multi-fiber yarns comprising a thermoplastic liquid crystal polymer;
providing a second thermoplastic material that is different from said first thermoplastic polymer, wherein a flow temperature of the second thermoplastic polymer is at least 10 degrees Celsius lower than a flow temperature of said first thermoplastic polymer; and
applying a treatment to the multi-fiber yarn to enhance bonding;
combining the first and second thermoplastic materials to form a filament;
heating said filament to form a heated filament; and
depositing said heated filament to build a three-dimensional object.

22. The process of claim 21, wherein the first and second thermoplastics are combined via a thermal draw, pultrusion, braiding, comingling, powder coating, spray coating, overbraiding, solvent coating, winding, serving, or wire drawing process.

23. The process of claim 21, further comprising subjecting said three-dimensional object to an elevated temperature sufficient for annealing to improve the physical cohesion between printed polymer lines and layers, wherein the elevated temperature is lower than the flow temperature of the first polymer, but higher than the flow temperature of the second polymer.

24. The process of claim 23, further comprising actively cooling the three-dimensional object to rapidly freeze the deposited, heated filament.

25. The process of claim 21, wherein deposition follows an extrusion pattern comprising oscillations, humps, beads, loops, or hooks to encourage mechanical interlocking between adjacent deposited traces and layers.
